(19) United States
(12) Patent Application Publication
(10) Pub. No.: US 2015/0178658 A1
(43) Pub. Date: Jun. 25, 2015

(54) Onboarding by Analyzing Practices of Best Hiring Managers

(71) Applicants: Yvonne Baur, Walldorf (DE); Anke Doerzapf, Walldorf (DE); Rebecca Sowards-Emmerd, Walldorf (DE)

(72) Inventors: Yvonne Baur, Walldorf (DE); Anke Doerzapf, Walldorf (DE); Rebecca Sowards-Emmerd, Walldorf (DE)

(73) Assignee: SUCCESSFACTORS, INC., South San Francisco, CA (US)

(21) Appl. No.: 14/136,096

(22) Filed: Dec. 20, 2013

(51) Int. Cl. G06Q 10/06; G06Q 10/10

(52) U.S. Cl. CPC G06Q 10/06393; G06Q 10/1053

(57) ABSTRACT

A system is described for improving an onboarding process by analyzing the practices of hiring managers who are successful in onboarding. The system includes analyzing completed onboarding processes to determine which hiring managers have been effective in onboarding. Effectiveness can include measuring attrition, employee performance, employee time to productivity, and employee surveys. Once successful hiring managers have been identified, the onboarding process of the successful hiring manager can be analyzed to identify one or more onboarding activities that are likely correlated with effective onboarding. This can include identifying onboarding activities that commonly appear in the onboarding processes and also onboarding activities that are frequently assigned and completed. These identified onboarding activities can be fed back to an onboarding path generator so that other hiring managers can incorporate these activities into their onboarding practice, thus improving the onboarding performance of the organization.

### BACKGROUND

Onboarding is a strategic process implemented by companies to integrate and acclimate new hires into an organization. Successful onboarding results in the new hire having high job satisfaction and being able to contribute at a desired level as quickly as possible. Unsuccessful onboarding results in low commitment and high attrition, which can lead to poor morale in the company. High attrition also results in additional time and/or money spent looking for other candidates to replace the resigned employee. Given that new hires typically decide whether they are going to stay with a company within the first six months, a successful onboarding program is an important part of many organizations.

However, running a successful onboarding program can have many challenges. First, there are multiple groups involved in the onboarding process so it is difficult to determine which group should be managing the onboarding process. Human resources are included since legal compliance (e.g., I-9s, W-4s, verification documentation, etc.) and corporate compliance (benefit forms, ESPP, etc.) are part of the onboarding process. Human resources set up formal meetings, lectures, and videos to introduce the new hire to their new jobs and organizations. The hiring manager is also included in the process since the hiring manager is better suited to introduce the new hire to his or her new role in the hiring manager's group. It is sometimes difficult to determine who is in charge of the onboarding process. Second, protocols for information sharing across different groups (or members of the same group) are typically not in place. For example, lessons learned by human resources regarding the onboarding process are often not shared with the hiring managers. Similarly, what has been successful for one hiring manager is not easily shared with other hiring managers.

### SUMMARY

In one embodiment, a computer-implemented method receives, by a processor, a plurality of onboarding objects associated with a set of hiring managers of an organization, each onboarding object including an onboarding path for integrating an employee to the organization and an onboarding score describing the effect of the onboarding path on the employee. The onboarding path includes a set of completed onboarding activities and a set of incomplete onboarding activities. The method then identifies, by the processor, a hiring manager from the set of hiring managers having a profile containing a consolidated onboarding score above a threshold score, the consolidated onboarding score describing the effectiveness of the hiring manager in onboarding and being derived from the plurality of onboarding objects associated with the hiring manager. The method then analyzes, by the processor, the plurality of onboarding objects associated with the identified hiring manager to identify an onboarding activity that is correlated with the consolidated onboarding score.

In another embodiment, a non-transitory computer readable storage medium stores one or more programs comprising instructions for receiving a plurality of onboarding objects associated with a set of hiring managers of an organization, each onboarding object including an onboarding path for integrating an employee to the organization and an onboarding score describing the effect of the onboarding path on the employee, wherein the onboarding path includes a set of completed onboarding activities and a set of incomplete onboarding activities, identifying a hiring manager from the set of hiring managers having a profile containing a consolidated onboarding score above a threshold score, the consolidated onboarding score describing the effectiveness of the hiring manager in onboarding and being derived from the plurality of onboarding objects associated with the hiring manager, and analyzing the plurality of onboarding objects associated with the identified hiring manager to identify an onboarding activity that is correlated with the consolidated onboarding score.

In another embodiment, a computer implemented system comprises one or more computer processors and a non-transitory computer-readable storage medium. The non-transitory computer-readable storage medium comprises instructions, that when executed, control the one or more computer processors to be configured for receiving a plurality of onboarding objects associated with a set of hiring managers of an organization, each onboarding object including an onboarding path for integrating an employee to the organization and an onboarding score describing the effect of the onboarding path on the employee, wherein the onboarding path includes a set of completed onboarding activities and a set of incomplete onboarding activities, identifying a hiring manager from the set of hiring managers having a profile containing a consolidated onboarding score above a threshold score, the consolidated onboarding score describing the effectiveness of the hiring manager in onboarding and being derived from the plurality of onboarding objects associated with the hiring manager, and analyzing the plurality of onboarding objects associated with the identified hiring manager to identify an onboarding activity that is correlated with the consolidated onboarding score.

The following detailed description and accompanying drawings provide a better understanding of the nature and advantages of the present disclosure.

### BRIEF DESCRIPTION OF THE DRAWINGS

FIG. 1 illustrates a system according to one embodiment;

FIG. 2 illustrates personalizing an OB path according to one embodiment;

FIG. 3 illustrates a system for creating an OB object according to one embodiment;

FIG. 4 illustrates a system for analyzing prior OB processes to determine best practices according to one embodiment;

FIG. 5 illustrates a filtering process to determine effective OB activities according to one embodiment;

FIG. 6 illustrates an OB activity according to one embodiment;

FIG. 7 illustrates an OB activity according to another embodiment;

FIG. 8 illustrates an OB activity according to another embodiment;

FIG. 9 illustrates an OB activity according to another embodiment;

FIG. 10 illustrates an OB activity according to another embodiment;

FIG. 11 illustrates splash page 1100 for a new hire;

FIG. 12 illustrates a process flow for generating an OB path according to one embodiment;

FIG. 13 illustrates a process flow for generating an OB object from a completed OB path according to one embodiment;

FIG. 14 illustrates a process flow for analyzing OB objects according to one embodiment; and

FIG. 15 illustrates an exemplary computer system according to one embodiment.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples alone or in combination with other features described below, and may further include modifications and equivalents of the features and concepts described herein.

Various embodiments described herein enable a member's onboarding practices to be shared with others in the organization. Together, the best onboarding practices can be determined and shared with other members, thereby promoting information sharing and improving the success of an organization's onboarding program. In one embodiment, the best hiring managers in an organization can be determined by evaluating their effectiveness in onboarding new hires. Hiring managers whose onboarding practices are effective can be identified. The onboarding processes of an effective hiring manager can be examined for similarities. For example, a successful hiring manager may always send flowers to the new hire during the first week. These similarities can be shared with other hiring managers so that they can take advantage of tactics which worked for the effective hiring managers.

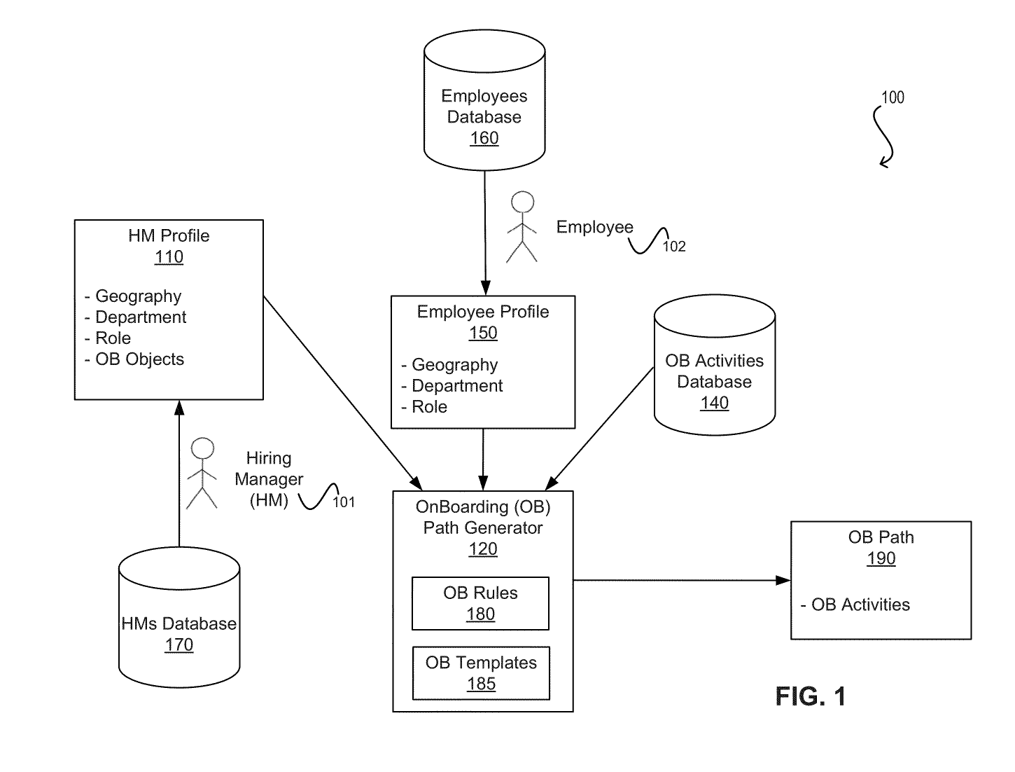

FIG. 1 illustrates system 100 according to one embodiment. System 100 includes onboarding (OB) path generator 120 which is configured to generate OB path 190. In one example, system 100 can generate OB path 190 in response to a request received from HM 101 for an OB path. The generated OB path can in turn be personalized by HM 101 before OB path 190 is initiated. OB path 190 is used by hiring manager (HM) 101 for onboarding employee 102 into an organization. During an onboarding process, HM 101 can initiate OB path 190 which includes a list of OB activities from OB activities database 140 that have been selected by OB path generator 120. Initiating OB path 190 can assign OB activities in OB path 190 to their respective owners. When an owner performs the activity, OB path 190 can be updated to signify that the activity has been completed. In some examples, the list of OB activities can be an ordered list specifying the order in which the OB activities should be completed.

In one embodiment, OB path generator 120 can select OB activities from OB activities database 140 according to OB rules 180. OB rules 180 include a set of rules that represent the logic within OB path generator 120. Each rule can depend on data within HM profile 110, employee profile 150, or both. For example, an OB rule can specify that an OB activity called “take new hire to eat in the corporate cafeteria” should be included in OB path 190 when the geography of HM 101 is at a location where there is a corporate cafeteria.

In another embodiment, OB path generator 120 can select OB activities from OB activities database 140 to include in OB path 190 according to a template in OB templates 185. A template can specify a set of OB activities and optionally an order that the OB activities are to be performed. In one example, the templates can be hiring manager specific (a hiring manager can create and save templates) or common throughout the organization (all hiring managers can access the same templates).

System 100 further includes HMs database 170. HMs database 170 includes a profile for each hiring manager in the organization. System 100 can retrieve HM profile 110 that corresponds to HM 101 from HMs database 170 when HM 101 requests an OB path. HM profile 110 includes descriptors belonging to HM 101, such as the geography which HM 101 is working out of, the department HM 101 belongs to, and the role of HM 101 in that department. In some examples, these descriptors can be used by OB rules 180 to select OB activities from OB activities database 140 or by OB templates 185 to select an appropriate template. Similarly, system 100 can select employee profile 150 from employees database 160. Employees database 160 can be any database of people, such as a database of employees that are a part of the organization or a database of new hires. Employee profile 150 can correspond to employee 102, which is the employee that HM 101 is onboarding into the organization. Employee profile 150 can include descriptors that belong to employee 102, such as the geography which employee 102 will be working out of, the department employee 102 will belong to, and the rule that employee 102 will have in that department. These descriptors can also be used by OB rules 180 to select OB activities that are best suited for employee 102 or be used by OB templates 185 to select a template that is appropriate for employee 102. In some examples, the OB activities can be legal compliance, corporate compliance, or soft interactions such as a assigning a buddy to employee 102 who can acclimate employee 102 to the department or the organization. OB path generator 120 can utilize descriptors from HM profile 110 and/or employee profile 150 to select OB activities to include in OB path 190. The descriptors from HM profile 110 and employee profile 150 can be imported or set by another system. For example, human resources may enter the details in employee profile 150 to keep track of employee 102. The same information can be made available to system 100. In some examples, the descriptors can be stored on a remote server.

In some embodiments, HM profile 110 can also include OB objects that are associated with HM 101. OB objects are containers that store OB paths previously used or defined by HM 101 to onboard employees. For example, an OB path previously used by HM 101 to onboard an existing employee can be stored in an OB object of HM profile 110. This OB path can be used to analyze the onboarding performance of the hiring manager. As another example, HM 101 can define OB path templates to be used when onboarding a new employee. For instance, HM 101 can have an OB template for onboarding remote new hires and another OB template for onboarding local new hires. OB objects can also store a corresponding OB score that describes the effectiveness of a given OB path. In one embodiment, the OB score can be used to determine how successful HM 101 has been in onboarding new hires. In some examples, HM 101's performance in onboarding over a predefined period of time (such as one year or two years) can be analyzed to determine whether HM 101 is a good hiring manager. In another embodiment, the OB score can be used to identify OB paths that are successful. Successful OB paths can be shared with other hiring managers or alternatively be provided as a default OB path when other hiring managers requests an OB path from system 100.

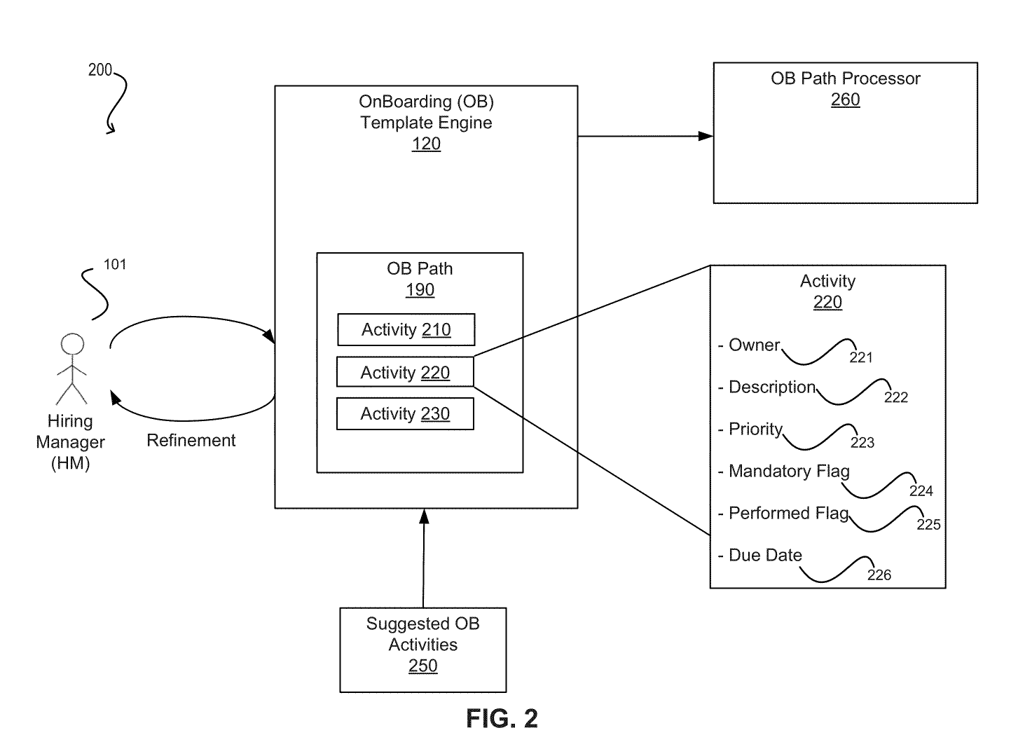

FIG. 2 illustrates personalizing an OB path according to one embodiment. Once HM 101 receives OB path 190 from system 100, HM 101 can continuously refine OB path 190 as he or she desires. Refinement can include rearranging OB activities, adding OB activities, and removing OB activities from OB path 190. In some embodiments, suggested OB activities 250 can be received by ON template engine 120 and presented to the hiring manager. For example, a suggestion can be “80% of our best managers assign buddies.” The suggestions can be received from other hiring managers, an automated system, or other source.

Here, OB path 190 includes OB activities 210, 220, and 240. Each OB activity includes content to perform the OB activity and multiple fields to describe the activity. For example, OB activity 220 includes owner field 221 which describes the owner of the activity 220. The owner of OB activity 220 is the person who is to perform OB activity 220. For example, HM 101 can be assigned to perform OB activity 220 when owner field 221 is set to an identifier that is associated with HM 101. Similarly, employee 102 can be assigned to perform OB activity 220 when owner field 221 is set to an identifier that is associated with employee 102. In some examples, owner field 221 can store multiple identifiers when multiple people are to perform activity 220. Eventually, a completed OB path can have a set of completed activities and a set of activities that were assigned but not completed. The completed OB path can be stored as part of HM profile 110 to be analyzed to determine which OB activities are effective. In some examples, only the completed OB activities are stored in the completed OB path.

Activity 220 can also include description field 222. Description field 222 stores content describing activity 220. In one example, description field 222 can store a text descriptor. For instance, description field 222 can store the phrase “Buy flowers for new hire” when the activity is to buy flowers for employee 102. Activity 220 can also include priority field 223. Priority field 223 can specify the importance of this activity by using a scale. The scale can be numerical or through a visual indicator. In one example, priority field 223 can be set to a value between 1 and 5 with 5 being the most important. In another example, priority field 223 can be set to a color selected from green, yellow, and red where red is the most important.

Activity 220 can also include mandatory flag 224. Mandatory flag 224 can be used to set whether activity 220 must be completed. OB path 190 can include multiple activities where some of the activities may be assigned but not completed. By setting mandatory flag 224, activity 220 must be completed during the OB process. Alternatively if mandatory flag 224 is not set, activity 220 is optional. Activity 220 can also include performed flag 225. Performed flag 225 can be set when activity 220 is performed. This allows a best practices engine to track which activities are completed in OB paths and to determine which performed activities are most effective to employees. Effective activities can be promoted by the best practices engine to other hiring managers as suggestions or by automatically incorporating the effective activities into their OB paths. Activity 220 can also include due date field 226, which can specify a date and time when activity 220 is to be performed or alternatively a date and time that activity 220 should be performed by. For example, due date field 226 can state that activity 220 is to be performed within the first week that the new hire starts the job or alternatively can specify the date and time of a meeting.

Once HM 101 is satisfied with OB path 190, OB path generator 120 transmits OB path 190 to OB path processor 260. OB path processor 260 can process OB path 190 by assigning OB activities to their respective owners (e.g., hiring manager, new hire, assigned buddy, etc.) and tracking the OB activities as they are performed. This is also known as the OB process. When the OB process is completed, OB path processor 260 can create an OB object that stores the results of the OB process. This OB object can be used for analysis to correlate performed OB activities with effective OB processes.

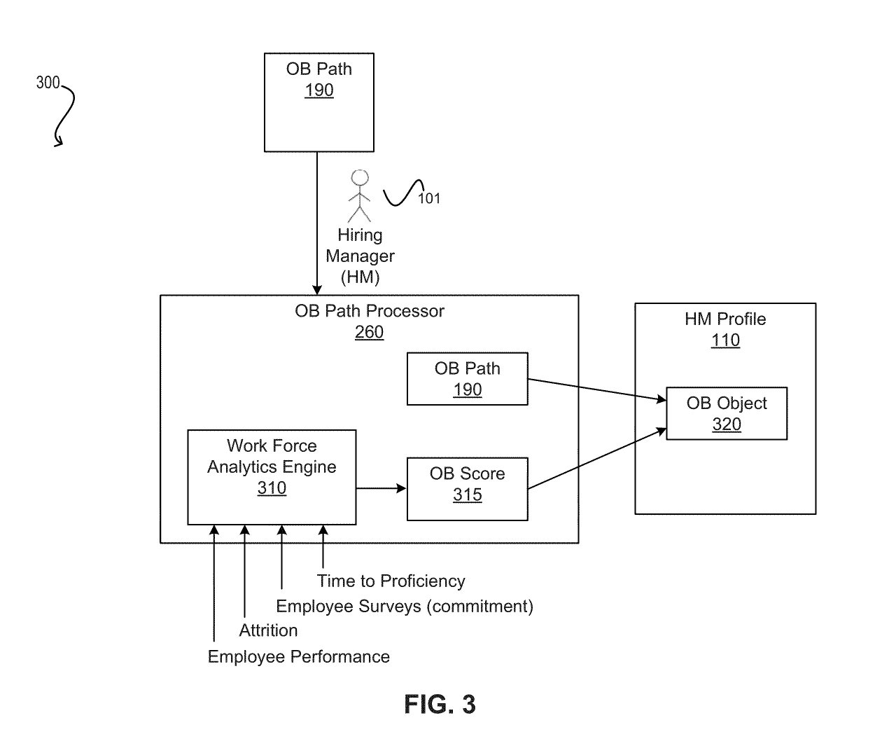

FIG. 3 illustrates system 300 for creating an OB object according to one embodiment. OB path processor 260 performs an OB process according to OB path 190. The OB process can include assigning OB activities that belong to OB path 190 to their respective owners. For example, a first OB activity in OB path 190 can be assigned to HM 101 (e.g., buy flowers for new hire or call to check in on new hire at the end of the first week). Or a first OB activity in OB path 190 can be assigned to employee 102 (e.g., complete paperwork by end of first week). After assigning OB activities, OB path processor 260 can monitor the OB activities to track when they are performed. When an OB activity is performed, OB path processor 260 can update the OB activity in OB path 190 to mark the OB activity as being completed.

OB path processor 260 includes work force analytics engine 310. Work force analytics engine 310 is configured to receive data associated with the effectiveness of the OB process and to generate OB score 315 that represents the overall success of the OB process. The data received by work force analytics engine 310 can be collected or generated by other components connected to system 300. In one example, the data can include surveys or measurements on employee 102's performance. In another example, the data can include attrition information (e.g., if the employee left the company or how long the employee was with the company before leaving). In another example, the data can include employee surveys that illustrate the employee's commitment to the company. In another example, the data can include a measurement of the length of time that it took for the employee to become proficient at the job. Once OB score 315 has been generated, OB path processor 260 can create OB object 320. OB object 320 is a container object that stores OB path 190 and OB score 315. In one embodiment, OB object 320 can be stored in HM profile 110. Over time, a collection of OB paths that are initiated by HM 101 and the corresponding effectiveness of the OB paths represented by an OB score is stored in HM profile 110. This data can be processed to determine whether HM 101 is a hiring manager that is successful in onboarding new hires and to determine what onboarding practices of HM 101 prove to be most effective. In other embodiments, OB object 320 can be stored in a central database along with OB objects associated with other hiring managers. A best practices engine can access the information in the central database to suggest OB activities to hiring managers, generate OB rules, create new OB activities, create new OB paths, or others.

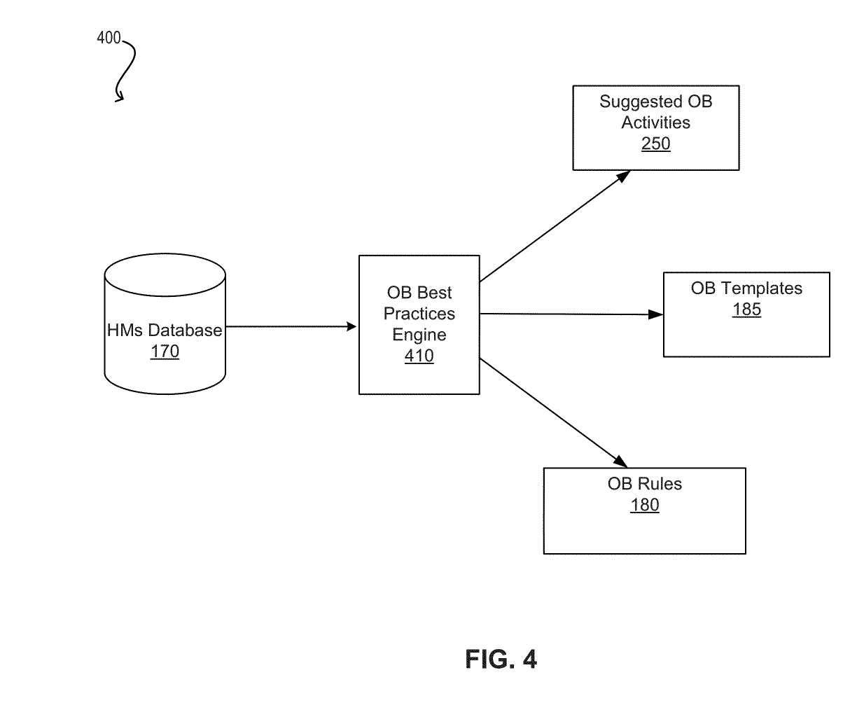

FIG. 4 illustrates system 400 for analyzing prior OB processes to determine best practices according to one embodiment. System 400 includes OB best practices engine 410 which receives data from HMs database 170. OB best practices engine 410 can analyze OB objects within HM profiles of HMs database 170 to determine which OB activities are effective in the OB process. In one embodiment, OB objects can be analyzed to determine which HMs are effective in onboarding new hires. Once the effective HMs are identified, the OB paths initiated by the effective HMs can be analyzed to determine what OB activities are commonly assigned or completed in the group of OB paths. These commonly assigned or completed OB activities can be tagged as effective OB activities and shared with other hiring managers. In one embodiment, OB best practices engine 410 can output effective OB activities as suggested OB activities 250, which can in turn be presented to a hiring manager when the hiring manager refines the OB path as shown in FIG. 2. In another embodiment, OB best practices engine 410 can add effective OB practices to new or existing OB templates in OB templates 185. In yet another embodiment, OB best practices engine 410 can create or modify existing rules in OB rules 180 based on effective OB activities. In one example, a rule can specify a similarity between a hiring manager and the successful hiring manager before the successful hiring manager's best practices are shared. This can allow similar hiring managers to influence one another. For example, effective OB best practices of a successful hiring manager in the northwest region can be applied to other hiring managers in the northwest region. Similarly, effective OB best practices of a successful hiring manager in engineering can be shared with other hiring managers in engineering while effective OB best practices of a successful hiring manager in accounting can be shared with other hiring managers in accounting.

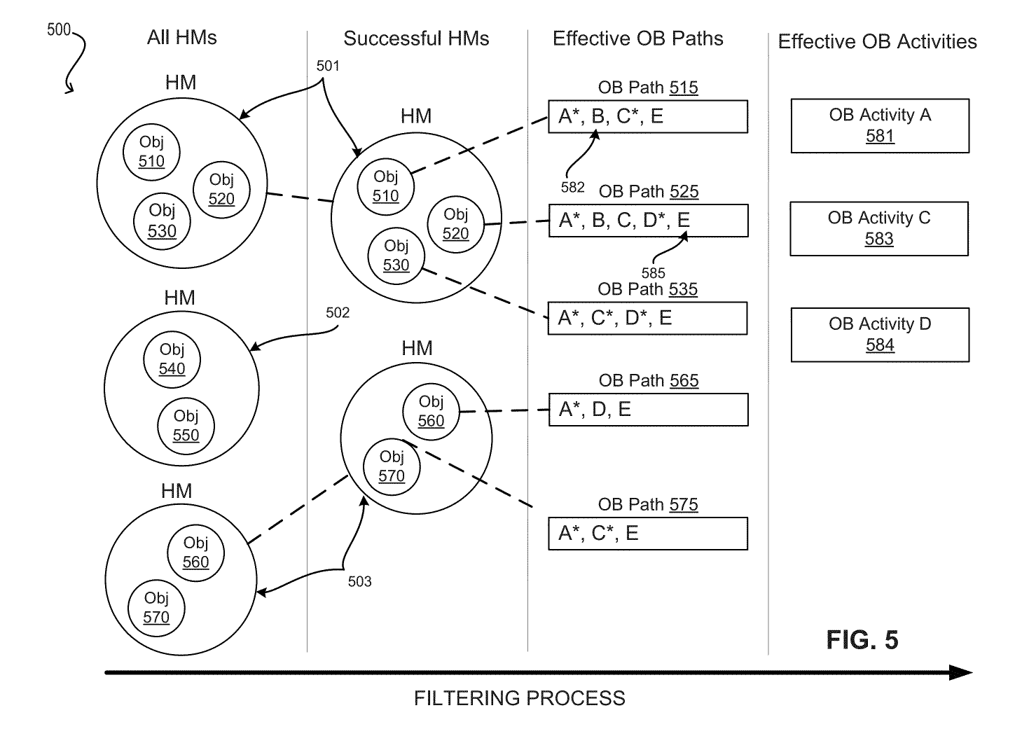

FIG. 5 illustrates filtering process 500 to determine effective OB activities according to one embodiment. Process 500 can be performed by OB best practices engine 410 of FIG. 4 or other processor configured to analyze completed OB processes to identify successful HMs and/or effective OB activities. Process 500 begins by examining the HM profiles in HM database 170 to determine which hiring managers are effective in onboarding. Here, HM database 170 includes HM profiles 501, 502, and 503. HM profile 501 includes OB objects 510, 520, and 530. HM profile 502 includes OB objects 540 and 550. Lastly, HM profile 503 includes OB objects 560 and 570.

In one embodiment, success of a hiring manager can be determined by evaluating the OB scores of OB objects stored within a HM profile. Statistical analysis such as mean, median, or mode can be applied to the OB scores to calculate an overall score for the hiring manager. In one example, hiring managers with an overall score above a threshold can be considered successful (i.e., effective) hiring managers. In another example, the hiring managers can be ordered according to their overall score and a predefined number of the highest scoring hiring managers can be considered successful hiring managers. In this context, a successful hiring manager is a hiring manager that has been effective in onboarding new hires. Here, HM profile 501 and HM profile 503 are identified as being associated with successful hiring managers and move forward in the filtering process.

After successful hiring managers have been identified, process 500 analyzes the OB paths that have been initiated by successful hiring managers. In one embodiment, all OB paths that have been initiated by a successful hiring manager are considered successful OB paths and can be analyzed. In another embodiment, a determination can be made to separate successful OB paths from unsuccessful OB paths of a successful hiring manager. For example, a hiring manager can be effective in onboarding domestic employees (e.g., have high OB scores for OB objects associated with domestic employees) but ineffective in onboarding international employees (e.g., have low OB scores for OB objects associated with international employees). The selected OB paths can be analyzed to identify OB activities that are popular amongst successful hiring managers or to identify trends in the onboarding practice of a successful hiring manager. These identified OB activities can be considered effective OB activities and can be shared with other hiring managers through suggestions, modified rules, or modified OB templates. In one embodiment, the analysis can include assigning an effectiveness score to each OB activity in the OB paths of the successful hiring managers. The effectiveness score can be calculated based on a variety of weighted factors that are used to dictate whether an OB activity is an effective OB activity. OB activities with an effectiveness score above a predetermined value can be considered effective OB activities. In another embodiment, all OB activities in selected OB paths can be identified as effective OB activities, thus simplifying the analysis process.

In one example, the factors can include whether an OB activity is assigned in a majority or all OB paths that are associated with a successful hiring manager. Having an OB activity assigned in all OB paths can have a heavier weight than when the OB activity is assigned in a majority of the OB paths. In another example, the factors can include whether an OB activity is assigned in the OB paths of all successful hiring managers. Having an OB activity assigned in the OB paths of all successful hiring managers can have a heavier weight than having an OB activity assigned in the OB paths of one successful hiring manager. In another example, the factors can include whether an OB activity is assigned in a majority of the OB paths of all successful hiring managers. In another example, the factors can include whether an OB activity is assigned but often not completed. These OB activities may have an effectiveness score set to zero. In other examples, the factors can include other variations of statistical analysis to determine whether inclusion of an OB activity was a factor in the hiring manager's success. In yet other examples, OB activities that are assigned but do not require completion are not factored into the effectiveness score since they do not need to be completed. For instance, an OB activity such as “introduce yourself to your teammates,” which does not require completion, may not be assigned an effectiveness score.

Here, process 500 can analyze OB paths 515, 525, and 535 of HM profile 501 and OB paths 565 and 575 of HM profile 503. Analysis can include assigning an effectiveness score to each OB activity that appears in OB paths 515, 525, 535, 545, 565, and 575. Each OB path includes a list of assigned OB activities, where completed OB activities are followed by an asterisk OB activity A 581 is assigned a high effectiveness score because it is included in each OB path and is always completed. In contrast, OB activity B 582 is assigned a low effectiveness score since while it is included in a majority of the OB paths for HM profile 501, the activity is never completed. OB activity C 583 is assigned a high effectiveness score since it is included in a majority of all the OB paths and is also completed in a majority of the OB paths. Similarly, OB activity D 584 is assigned a high effectiveness score since although it is included in a majority of the OB paths for HM profile 501 and a minority of the OB paths overall, it is always completed when assigned. In contrast, OB activity E 585 is assigned a low effectiveness score since it is never completed even though it is assigned in every OB path.

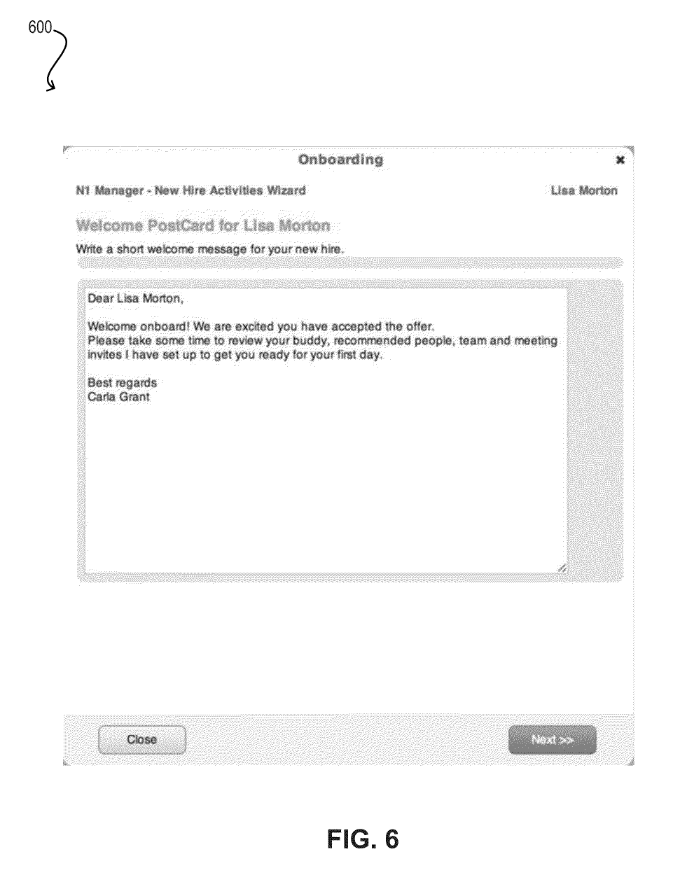

FIG. 6 illustrates an OB activity according to one embodiment. OB activity 600, which can include computer code to generate the user interface as shown in FIG. 6, is a welcome postcard for a new hire. OB activity 600, as shown, invites the hiring manager to write a message to welcome the new hire to the organization. In one example, OB activity 600 can include a default message which the hiring manager can edit or add to. When the next button is selected, OB activity 600 has been completed and can be marked as processed so that its completion can be tracked accordingly.

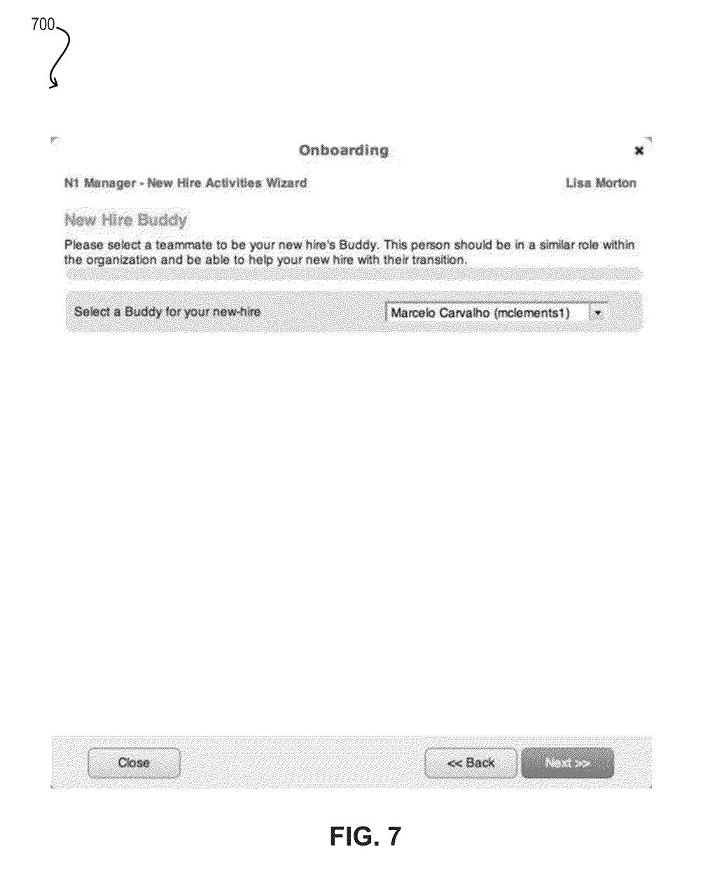

FIG. 7 illustrates an OB activity according to another embodiment. OB activity 700 is a graphical user interface to select a buddy for the new hire. As shown, a hiring manager can select a new buddy for a new hire to help transition the new hire into his or her new role. Tips can be provided to the hiring manager to notify the hiring manager that the buddy should be in a similar role within the organization and be able to help the new hire in the transition. A pull down field is included in OB activity 700 to allow the hiring manager to select an active employee in the organization that is best suited to mentor the new hire. When the next button is selected, OB activity 700 has been completed and can be marked as processed.

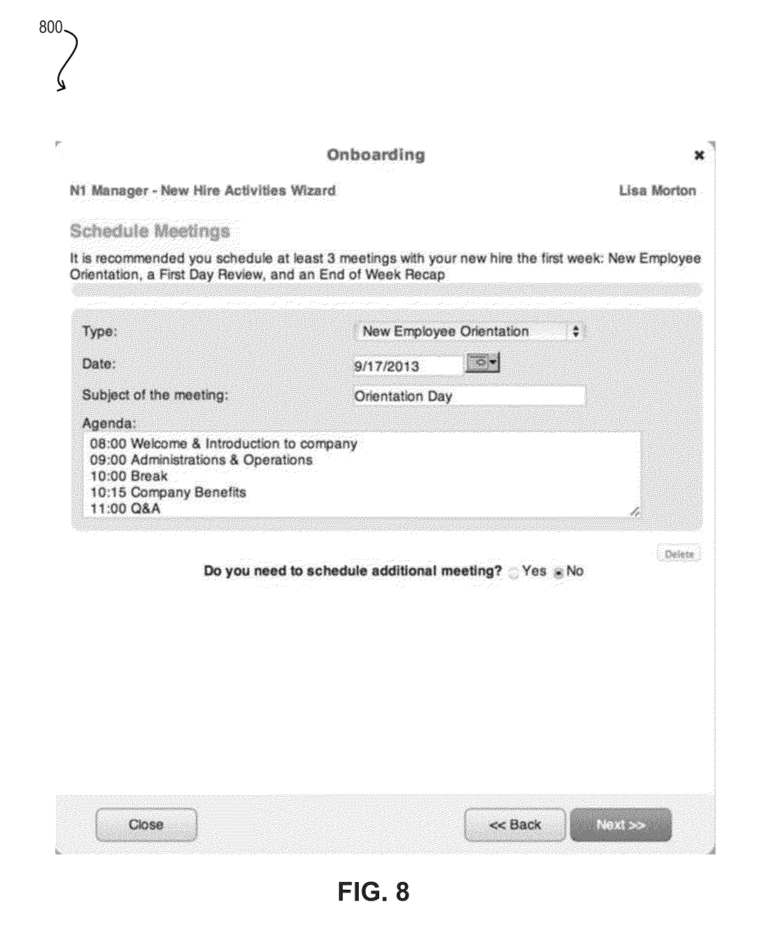

FIG. 8 illustrates an OB activity according to another embodiment. OB activity 800 is a graphical user interface to schedule meetings with the new hire. As shown, OB activity 800 recommends the hiring manager to schedule at least three meetings with the new hire in the first week. Drop down fields are included in OB activity 800 to set meetings with the new hire. Drop down fields can allow the hiring manager to set details of a meeting such as the type of meeting, the date of the meeting, the subject of the meeting, and a meeting agenda. Once the meeting details are set, OB activity 800 concludes when the next button is selected, signifying that OB activity 800 has been completed.

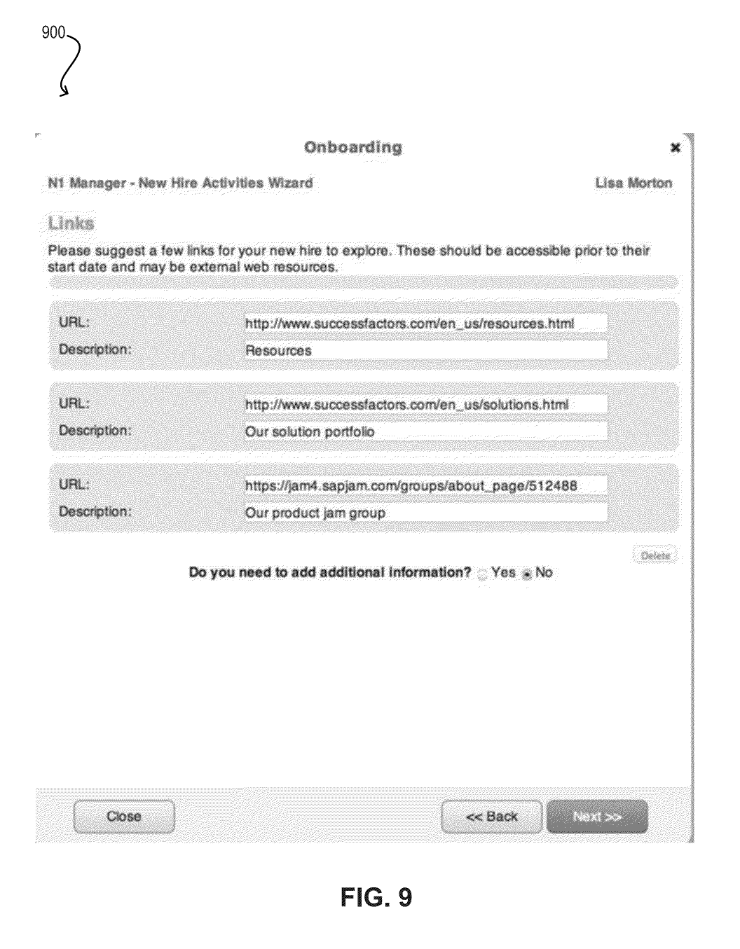

FIG. 9 illustrates an OB activity according to another embodiment. OB activity 900 is a graphical user interface for selecting useful links for the new hire to explore. As shown, OB activity 900 includes fields to enter a URL followed by a description of the URL. Once the URLs and descriptions have been provided and the next button is selected, OB activity 900 can be marked as completed.

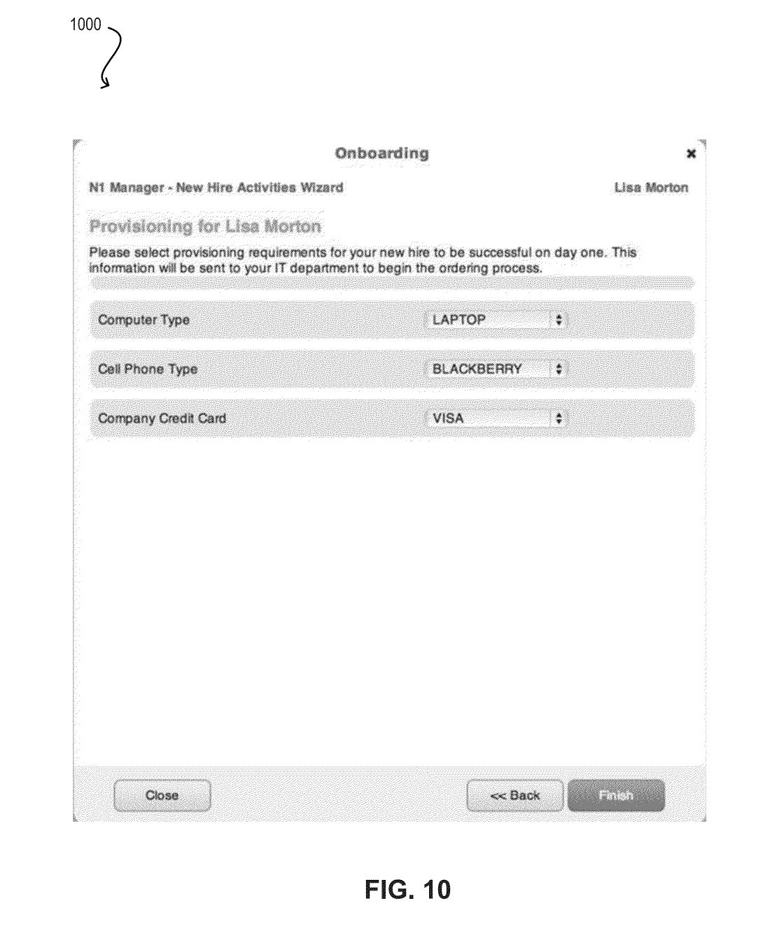

FIG. 10 illustrates an OB activity according to another embodiment. OB activity 1000 is a graphical user interface for provisioning hardware to the new hire. As shown, OB activity 1000 includes multiple drop down fields which allow the hiring manager to provision hardware such as computers, cell phones, and credit cards for the new hire. Once the hiring manager has provisioned the hardware for the new hire by using the drop down fields, OB activity 1000 is completed when the hiring manager selects the finish button.

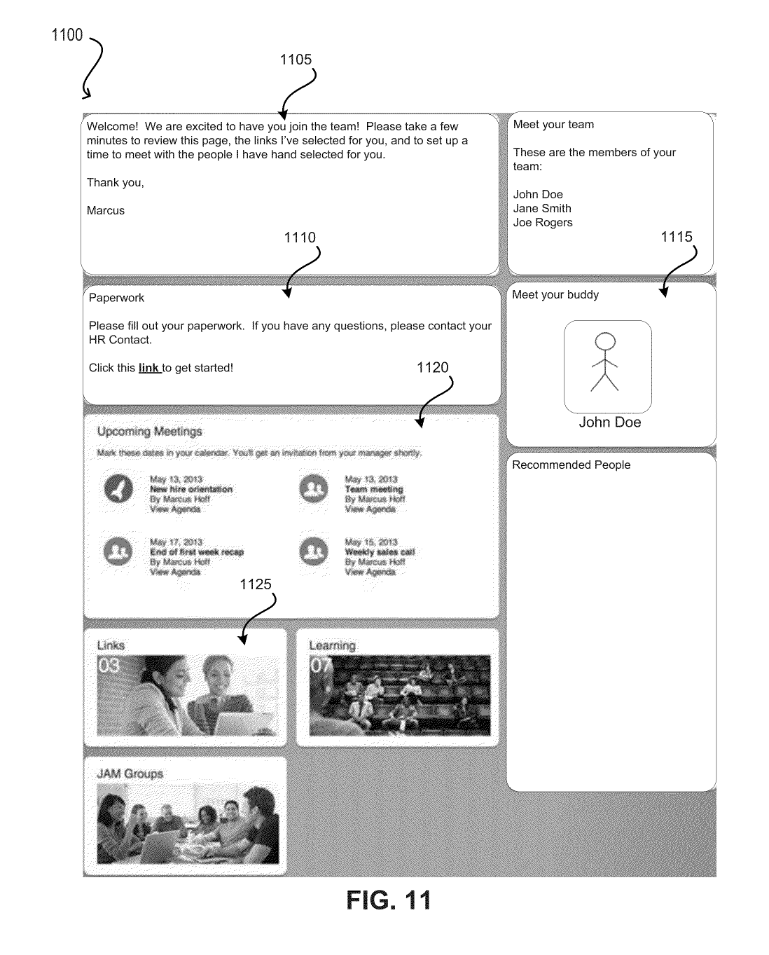

FIG. 11 illustrates splash page 1100 for a new hire. Splash page 1100 includes a plurality of tiles that provide information to the new hire that is useful during the onboarding process. Some tiles can present information generated from completed OB activities (such as welcome tile 1105 being generated from OB activity 600, buddy tile 1115 generated from OB activity 700, or links tile 1125 generated from OB activity 900, all of which were completed by the hiring manager). Other tiles can present OB activities for the new hire to complete (such as paperwork tile 1110 and upcoming meetings tile 1120, both of which are assigned to the new hire). As shown, OB activities assigned by different people or groups can be presented simultaneously on splash page 1100. For instance, an HR group assigns paperwork to the new hire through paperwork tile 1110 while a hiring manager assigns meetings to the new hire through upcoming meetings tile 1120. Upcoming meetings tile 1120 is an example of an OB activity that has been assigned to both the hiring manager and the new hire.

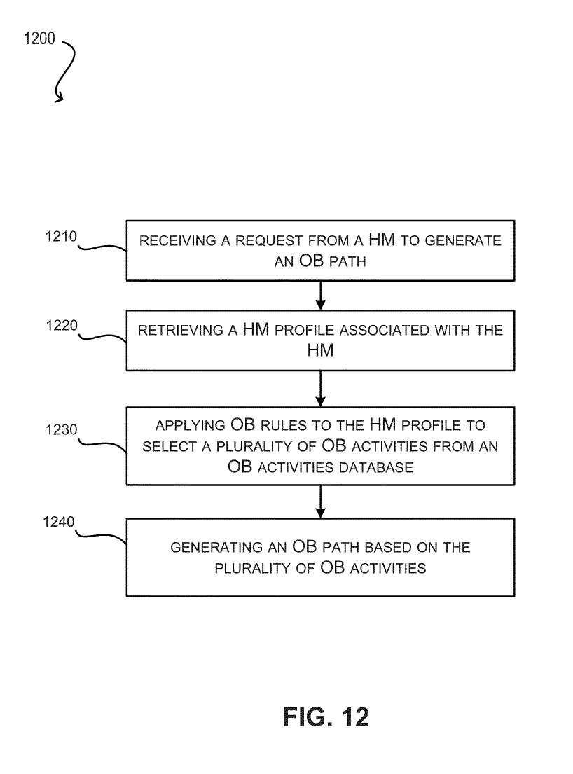

FIG. 12 illustrates a process flow for generating an OB path according to one embodiment. Process 1200 can be stored in computer readable medium and executed by a processor such OB path generator 120 in FIG. 1. Process 1200 begins by receiving a request from a hiring manager to generate an OB path at 1210. The OB path can be used by the hiring manager to onboard a new hire. After the request is received, process 1200 continues by receiving a HM profile associated with the hiring manager. The HM profile can include details about the hiring manager such as the hiring manager's rule, group, etc. The HM profile can also include OB objects storing previously used OB paths and their corresponding OB scores. Process 1200 can apply OB rules to the data in the HM profile to select a plurality of OB activities from an OB activities database at 1230. The selected activities can be used to generate an OB path at 1240. In other embodiments, an employee profile containing details on the new hire can also be used to select the plurality of OB activities. This can result in OB activities that are dependent on both the hiring manager and the new hire.

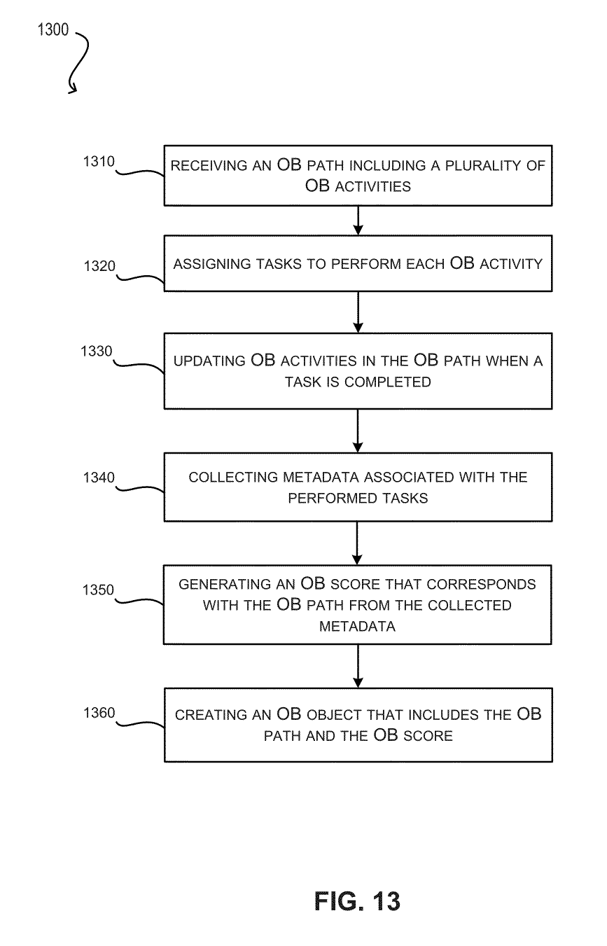

FIG. 13 illustrates a process flow for generating an OB object from a completed OB path according to one embodiment. Process 1300 can be stored in computer readable medium and executed by a processor such as OB path processor 260 in FIG. 2. Process 1300 begins by receiving an OB path including a plurality of OB activities at 1310. Process 1300 then assigns granular activities to perform each OB activity at 1320. The granular activities can be assigned to the hiring manager, the new hire, or to other members of the organization such as the buddy assigned to the new hire by the hiring manager. Once granular activities have been assigned, process 1300 continues by updating OB activities in the OB path when a granular activity is completed at 1330. The OB path can be periodically updated as granular activities are completed. When the OB process ends, the OB path may contain a set of OB activities that were completed and another set of OB activities that were incomplete. At the completion of the OB process, process 1300 collects metadata associated with the performed granular activities at 1340. The metadata collected can be a measurement of the period of time that it took for the new hire to become proficient at the job, a measurement of the new hire's commitment to the organization, attrition statistics, and measurements on the new hire's performance. This collected metadata can be used to generate an OB score that describes the effectiveness of the OB path at 1350. Once the OB score is generated, process 1300 can create an OB object that includes the OB path and the OB score. In one example, the OB object can be stored in the HM profile that is associated with the hiring manager.

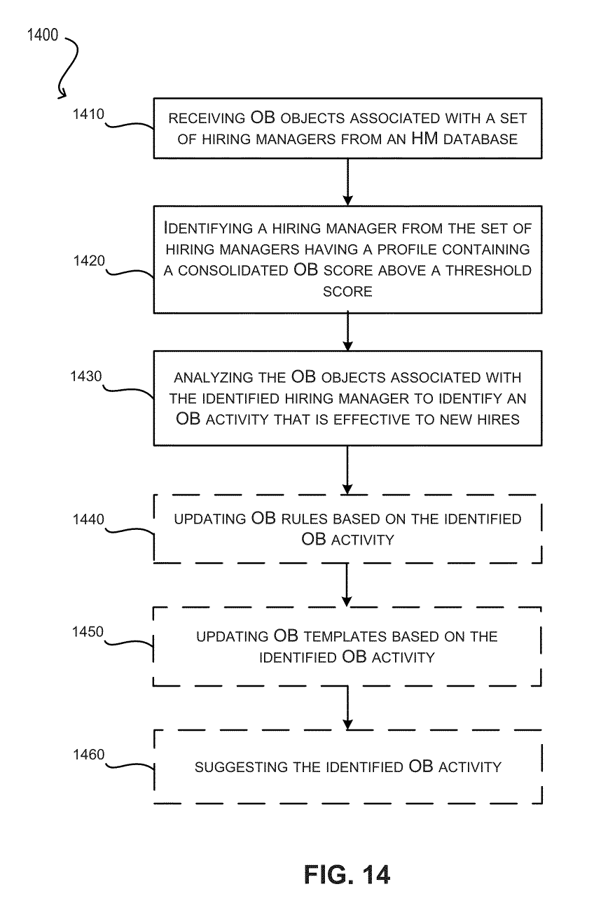

FIG. 14 illustrates a process flow for analyzing OB objects according to one embodiment. Process 1400 can be stored in computer readable medium and executed by a processor such as OB best practices engine 310 in FIG. 4. Process 1400 begins by receiving OB objects associated with a set of hiring managers from an HM database at 1410. The OB objects include an OB path containing OB activities that were and were not completed during an onboarding process. The OB objects can also include an OB score for the OB path that describes the overall effectiveness of the OB path to onboard an employee. Process 1400 then continues by identifying a hiring manager from the set of hiring managers having a HM profile containing a consolidated OB score above a threshold score at 1420. In some examples, the identification process can include performing statistical analysis on the OB scores of OB objects to generate the consolidated OB score for the HM profile. HM profiles with a consolidated score above the threshold score can be identified as belonging to successful hiring managers. Process 1400 continues by analyzing the OB objects associated with the identified hiring manager to identify an OB activity that is effective to new hires. The identified OB activity can be an activity that appears often in the OB paths initiated by the identified hiring manager. In some examples, the plurality of onboarding objects can be analyzed to identify a plurality of unique OB activities from the plurality of OB paths initiated by the identified hiring manager. Multiple weighted factors can be applied to each unique OB activity found in the OB paths associated with the identified hiring manager to calculate the effectiveness score for each OB activity. An OB activity can be selected based on the effectiveness score.

Once an OB activity has been identified, process 1400 can optionally update OB rules based on the identified OB activity at 1440. The OB rules can be used by an OB path generator to select OB activities to include in an OB path. OB rules can receive one or more inputs such as hiring manager details or employee details and can return one or more OB activities to be included in an OB path. Updating an OB rule can include changing the logic of that rule to return an OB activity. Process 1400 can also optionally update OB templates based on the identified OB activity at 1450. Updating an OB template can include adding the identified OB activity into an OB template. The OB templates can be stored in an OB path generator or as part of an HM profile. Process 1400 can also optionally suggest the identified OB activity at 1460. Suggestions can be provided to the hiring manager while the hiring manager is refining the OB path as shown in FIG. 2.

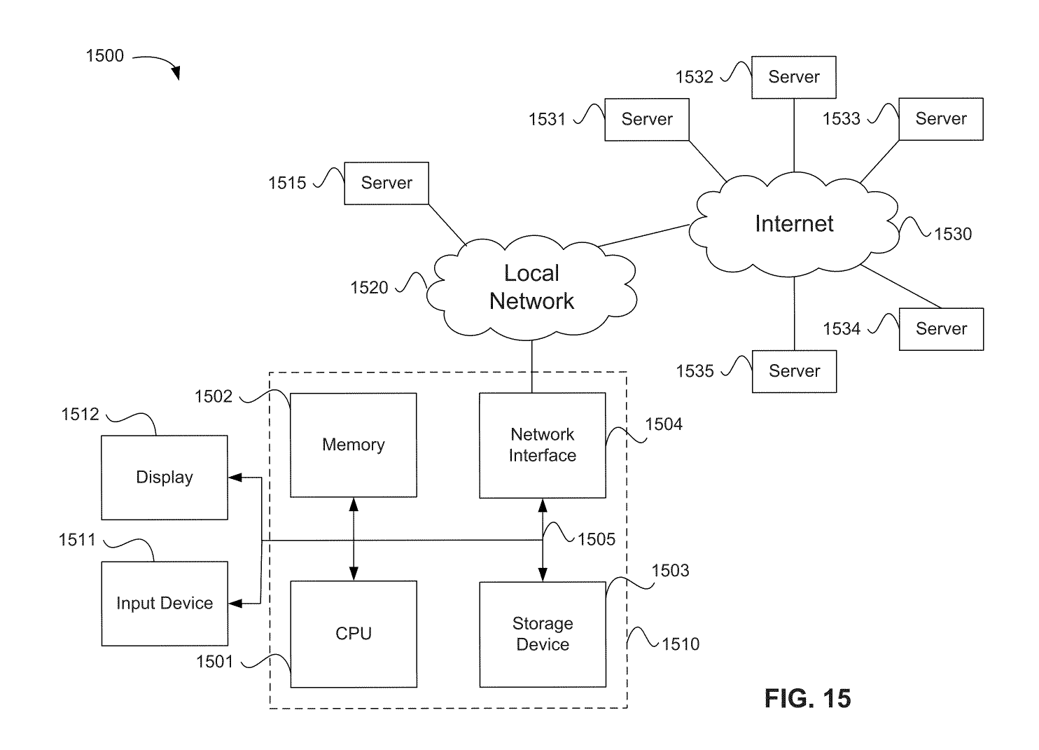

An exemplary computer system 1500 is illustrated in FIG. 15. Computer system 1510 includes bus 1505 or other communication mechanism for communicating information, and a processor 1501 coupled with bus 1505 for processing information. Computer system 1510 also includes a memory 1502 coupled to bus 1505 for storing information and instructions to be executed by processor 1501, including information and instructions for performing the techniques described above, for example. This memory may also be used for storing variables or other intermediate information during execution of instructions to be executed by processor 1501. Possible implementations of this memory may be, but are not limited to, random access memory (RAM), read only memory (ROM), or both. A storage device 1503 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 1503 may include source code, binary code, or software files for performing the techniques above, for example. Storage device and memory are both examples of computer readable mediums.

Computer system 1510 may be coupled via bus 1505 to a display 1512, such as a cathode ray tube (CRT) or liquid crystal display (LCD), for displaying information to a computer user. An input device 1511 such as a keyboard and/or mouse is coupled to bus 1505 for communicating information and command selections from the user to processor 1501. The combination of these components allows the user to communicate with the system. In some systems, bus 1505 may be divided into multiple specialized buses.

Computer system 1510 also includes a network interface 1504 coupled with bus 1505. Network interface 1504 may provide two-way data communication between computer system 1510 and the local network 1520. The network interface 1504 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 1504 sends and receives electrical, electromagnetic, or optical signals that carry digital data streams representing various types of information.

Computer system 1510 can send and receive information, including messages or other interface actions, through the network interface 1504 across a local network 1520, an Intranet, or the Internet 1530. For a local network, computer system 1510 may communicate with a plurality of other computer machines, such as server 1515. Accordingly, computer system 1510 and server computer systems represented by server 1515 may form a cloud computing network, which may be programmed with processes described herein. In the Internet example, software components or services may reside on multiple different computer systems 1510 or servers 1531-1535 across the network. The processes described above may be implemented on one or more servers, for example. A server 1531 may transmit actions or messages from one component, through Internet 1530, local network 1520, and network interface 1504 to a component on computer system 1510. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method, comprising:
receiving, by a processor, a plurality of onboarding objects associated with a set of hiring managers of an organization, each onboarding object including an onboarding path for integrating an employee to the organization and an onboarding score describing the effect of the onboarding path on the employee, wherein the onboarding path includes a set of completed onboarding activities and a set of incomplete onboarding activities;
identifying, by the processor, a hiring manager from the set of hiring managers having a profile containing a consolidated onboarding score above a threshold score, the consolidated onboarding score describing the effectiveness of the hiring manager in onboarding and being derived from the plurality of onboarding objects associated with the hiring manager; and
analyzing, by the processor, the plurality of onboarding objects associated with the identified hiring manager to identify an onboarding activity that is correlated with the consolidated onboarding score.

2. The computer-implemented method of claim 1, further comprising:
receiving, by the processor, an onboarding request from another hiring manager of the organization to integrate another employee to the organization; and
providing, by the processor, the identified onboarding activity to the another hiring manager.

3. The computer-implemented method of claim 2, further comprising:
determining, by the processor, the applicability of the identified onboarding activity to the another hiring manager by evaluating at least one attribute of the another hiring manager, wherein the onboarding activity is provided to the another hiring manager in response to the determination.

4. The computer-implemented method of claim 2, wherein the identified onboard activity is provided to the another hiring manager as part of another onboarding path.

5. The computer-implemented method of claim 4, wherein the identified onboard activity is set as a mandatory activity in the another onboarding path.

6. The computer-implemented method of claim 1, wherein analyzing the plurality of onboarding objects comprises:
identifying, by the processor, a plurality of unique onboarding activities from the plurality of onboarding objects associated with the identified hiring manager;
assigning, by the processor, an effectiveness score to each of the plurality of unique onboarding activities based on the frequency that they appear in the plurality of onboarding objects associated with the identified hiring manager; and
selecting, by the processor, an onboarding activity from the plurality of unique onboarding activities based on the effectiveness score.

7. The computer-implemented method of claim 1, further comprising:
updating, by the processor, an onboarding rule to include the identified onboarding activity.

8. A non-transitory computer readable storage medium storing one or more programs, the one or more programs comprising instructions for:
receiving a plurality of onboarding objects associated with a set of hiring managers of an organization, each onboarding object including an onboarding path for integrating an employee to the organization and an onboarding score describing the effect of the onboarding path on the employee, wherein the onboarding path includes a set of completed onboarding activities and a set of incomplete onboarding activities;
identifying a hiring manager from the set of hiring managers having a profile containing a consolidated onboarding score above a threshold score, the consolidated onboarding score describing the effectiveness of the hiring manager in onboarding and being derived from the plurality of onboarding objects associated with the hiring manager; and
analyzing the plurality of onboarding objects associated with the identified hiring manager to identify an onboarding activity that is correlated with the consolidated onboarding score.

9. The non-transitory computer readable storage medium of claim 8, further comprising:
receiving an onboarding request from another hiring manager of the organization to integrate another employee to the organization; and
providing the onboarding activity to the another hiring manager.

10. The non-transitory computer readable storage medium of claim 9, further comprising:
determining the applicability of the identified onboarding activity to the another hiring manager by evaluating at least one attribute of the another hiring manager, wherein the onboarding activity is provided to the another hiring manager in response to the determination.

11. The non-transitory computer readable storage medium of claim 9, wherein the identified onboard activity is provided to the another hiring manager as part of another onboarding path.

12. The non-transitory computer readable storage medium of claim 11,
wherein the identified onboard activity is set as a mandatory activity in the another onboarding path.

13. The non-transitory computer readable storage medium of claim 8, wherein analyzing the plurality of onboarding objects comprises:
identifying a plurality of unique onboarding activities from the plurality of onboarding objects associated with the identified hiring manager;
assigning an effectiveness score to each of the plurality of unique onboarding activities based on the frequency that they appear in the plurality of onboarding objects associated with the identified hiring manager; and
selecting an onboarding activity from the plurality of unique onboarding activities based on the effectiveness score.

14. The non-transitory computer readable storage medium of claim 8, further comprising:
updating an onboarding rule to include the identified onboarding activity.

15. A computer implemented system, comprising:
one or more computer processors; and
a non-transitory computer-readable storage medium comprising instructions, that when executed, control the one or more computer processors to be configured for:
receiving a plurality of onboarding objects associated with a set of hiring managers of an organization, each onboarding object including an onboarding path for integrating an employee to the organization and an onboarding score describing the effect of the onboarding path on the employee, wherein the onboarding path includes a set of completed onboarding activities and a set of incomplete onboarding activities;
identifying a hiring manager from the set of hiring managers having a profile containing a consolidated onboarding score above a threshold score, the consolidated onboarding score describing the effectiveness of the hiring manager in onboarding and being derived from the plurality of onboarding objects associated with the hiring manager; and
analyzing the plurality of onboarding objects associated with the identified hiring manager to identify an onboarding activity that is correlated with the consolidated onboarding score.

16. The computer implemented system of claim 15, further comprising:
receiving an onboarding request from another hiring manager of the organization to integrate another employee to the organization; and
providing the onboarding activity to the another hiring manager.

17. The computer implemented system of claim 16, further comprising:
determining the applicability of the identified onboarding activity to the another hiring manager by evaluating at least one attribute of the another hiring manager, wherein the onboarding activity is provided to the another hiring manager in response to the determination.

18. The computer implemented system of claim 16, wherein the identified onboard activity is provided to the another hiring manager as part of another onboarding path.

19. The computer implemented system of claim 18, wherein the identified onboard activity is set as a mandatory activity in the another onboarding path.

20. The computer implemented system of claim 15, wherein analyzing the plurality of onboarding objects comprises:
identifying a plurality of unique onboarding activities from the plurality of onboarding objects associated with the identified hiring manager;
assigning an effectiveness score to each of the plurality of unique onboarding activities based on the frequency that they appear in the plurality of onboarding objects associated with the identified hiring manager; and
selecting an onboarding activity from the plurality of unique onboarding activities based on the effectiveness score.
